(19) United States
(12) Patent Application Publication
(10) Pub. No.: US 2005/0213947 A1
(43) Pub. Date: Sep. 29, 2005

(54) Optical disc recorder

(75) Inventor: Atsushi Iwamoto, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/088,176

(22) Filed: Mar. 24, 2005

(30) Foreign Application Priority Data
Mar. 24, 2004 (JP) 2004-086205

(51) Int. Cl. H04N 5/781

(52) U.S. Cl. 386/126

(57) ABSTRACT

In an optical disc recorder, a time necessary for performing preparation processing prior to start of recording of signals on an optical disc after an instruction of start of recording is inputted is shortened. A search of power calibration area is started while the optical disc is revolved at a double speed of a normal revolution speed promptly when the optical disc is mounted on a revolution table. When the search of the power calibration area is completed, the optical disc recorder shifts to standby mode for waiting the instruction of start of recording. When the instruction of start of recording is inputted, a buffer starts to accumulate MPEG encodes signals generated by an MPEG encoder, and an optimum power control is carried out while revolving the optical disc at the normal revolution speed. When the optimum power control is completed, and the most suitable laser strength for the optical disc loaded on is found, the recording of the signals accumulated into the buffer onto the optical disc is started.

### BACKGROUND OF THE INVENTION

1 . Field of the Invention

The present invention relates to an optical disc recorder used for recording television broadcast signals on a recording face of an optical disc.

2 . Description of the Related Art

Conventionally, an optical disc recorder for recording television broadcast signals is put in practical use. Various classifications of optical discs to which signals can be recorded are supplied from various manufacturing corporations. Since sensitivity for laser beam of each recordable optical disc can vary in a range of a standard, the optical disc recorder carries out optimum power control (OPC) so as to optimize intensity of laser beam before recording the signals onto the optical disc.

FIG. 4 shows operations of such a conventional optical disc recorder at an initial state of recording of the signals onto the optical disc in chronological order. Under a state that the optical disc is loaded on the optical disc recorder, when a recording key of a wireless remote controller is operated, the optical disc recorder starts the recording. When the conventional optical disc recorder records the signals onto the optical disc, it searches an area to which the optimum power control is performed, that is, a power calibration area (PCA), first. Subsequently, the optical disc recorder performs the optimum power control on the power calibration area. The television broadcast signals, however, are serially delivered while the optical disc recorder searches the power calibration area and performs the optimum power control after the recording key is operated. In order to recode the television broadcast signals onto the optical disc just after the recording key is operated without exception, the conventional optical disc recorder carries out the compression and encoding of the television broadcast signals, temporarily accumulating the processed signals into a buffer while the above-mentioned preparation are processed, and recording the signals onto the optical disc after the optimum power control is completed.

In another conventional optical disc apparatus shown in, for example, Publication of Unexamined Japanese Patent application No. 2003 -272157, a power calibration area is formed by erasing an area to which the optimum power control has been performed so as to search the power control area easily. In still another conventional optical disc apparatus shown in, for example, Publication of Unexamined Japanese Patent application No. 2003 -281745, an optical pickup is moved to an initial position with using the power calibration area.

In the above-mentioned conventional optical disc recorder, since several tens seconds are necessary for performing the preparation of the recording such as search of the power calibration area and performing of the optimum power control, a large scale buffer is necessary for accumulating the television broadcast signals delivered meanwhile. It is a cause of increasing the cost of the optical disc recorder. When it is assumed that a term of about eight seconds is necessary for searching the power calibration area and a term of about eight seconds is necessary for performing the optimum power control, it needs a buffer having a capacity enough to accumulate the television broadcast signals of more than sixteen seconds. When a buffer of enough capacity cannot be implemented on the optical disc recorder, overflow of the buffer can be prevented due to providing a delay time to start the buffering. It, however, results to invite a fall of convenience of the optical disc recorder, since the television broadcast signals just after the recording key is operated cannot be recorded.

### SUMMARY OF THE INVENTION

A purpose of the present invention is to provide an optical disc recorder in which a capacity of a buffer can be reduced by shortening time until the recording of signals being started after an instruction of start of recording is inputted, and a cost of the apparatus can be reduced.

An optical disc recorder in accordance with an aspect of the present invention comprises: a tuner receiving television broadcast signals; an encoder for compressing and encoding the television broadcast signals received by the tuner; a buffer for temporarily accumulating signals compressed and encoded by the encoder; a modulator for modulating the signals accumulated into the buffer to signals appropriate to be recorded on an optical disc; a spindle motor for revolving the optical disc; an optical pickup for emission of laser beam to the optical disc while it is revolved by the spindle motor so as to record the signals modulated by the modulator onto the optical disc; and a controller for controlling each component of the recorder.

The spindle motor revolves the optical disc just after the optical disc is mounted on the recorder at a first revolution speed, the optical pickup emits the laser beam to the optical disc revolved and receives reflected light from the optical disc, and the controller judges a classification of the optical disc the recorder based on the reflected light received by the optical pickup. When the classification of the optical disc is judged, the spindle motor maintains revolution of the optical disc at the first revolution speed and the optical pickup emits the laser beam to the optical disc for searching a power calibration area. And when the power calibration area is searched, the controller shifts to standby mode to wait an instruction to start recording of television broadcast signals onto the optical disc.

By such a configuration, the search of the power calibration area is performed subsequent to the judgment of the classification of the optical disc just after the optical disc is mounted on the optical disc recorder. Thus, when the instruction to start of recording is inputted, the power control area is already searched, so that the optical disc apparatus can start the optimum power control immediately. Consequently, a time necessary for performing preparation processing prior to start of recording of the television broadcast signals onto the optical disc after the instruction of start of recording is inputted can be shortened.

### BRIEF DESCRIPTION OF THE DRAWINGS

FIG. 1 is block diagram showing a configuration of an optical disc recorder in accordance with an embodiment of the present invention;

FIG. 2 is a time chart showing operations of the above-mentioned optical disc recorder at an initial state of recording in chronological order;

FIG. 3 is a flowchart showing operations of the optical disc recorder from loading of an optical disc to recording of television broadcast signals onto the optical disc; and

FIG. 4 is a time chart showing operations of a conventional optical disc recorder at an initial state of recording in chronological order.

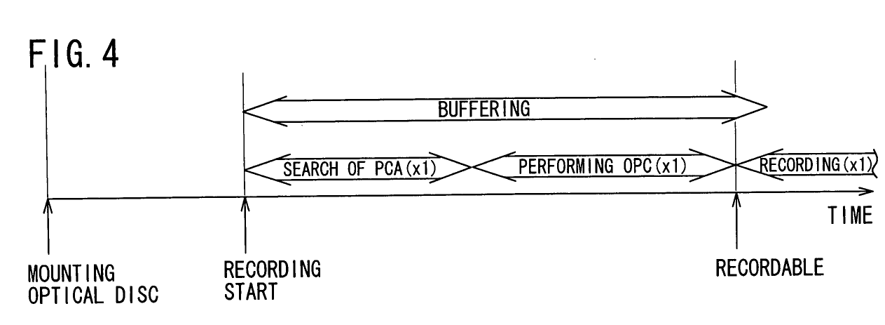

### DETAILED DESCRIPTION OF THE EMBODIMENT

An optical disc recorder in accordance with an embodiment of the present invention is described with reference to figures.

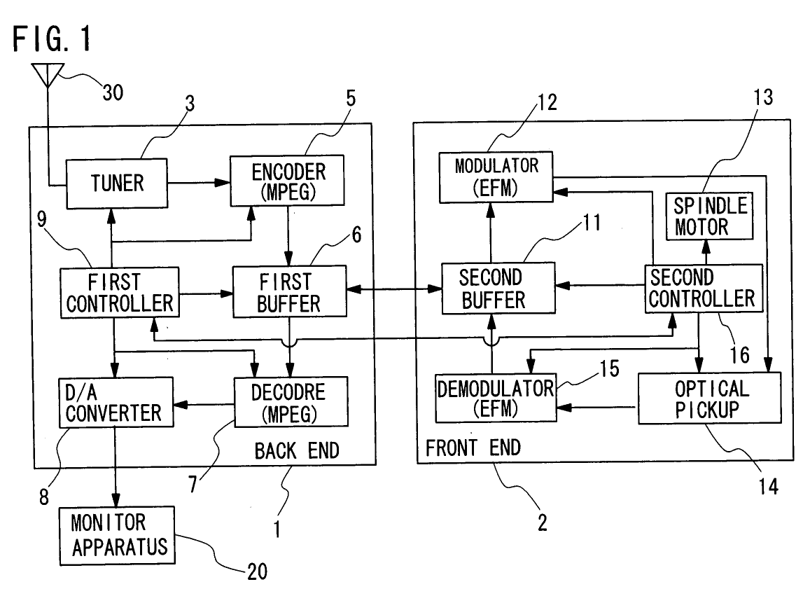

FIG. 1 shows a constitution of a DVD (Digital Versatile Disc) recorder for recording television broadcast signals onto a recordable optical disc such as DVD-R, DVD-RW, DVD-RAM, and so on, which is an example of the optical disc recorder in the embodiment. The optical disc recorder has a backend 1 for processing the entire of the recorder and a front end 2 for recording (or writing) and reproducing (or reading) of signals onto and from an optical disc.

The backend 1 comprises a tuner 3 receiving television broadcast signals through antenna 30, an MPEG (Moving Picture Experts Group) encoder 5 for compressing and encoding the television broadcast signals received by the tuner 3 to signals compliant with following MPEG standard, a first buffer 6 for temporarily accumulating the signals compressed and encoded by the MPEG encoder 5, an MPEG decoder 7 for decoding the signals accumulated into the first buffer 6, a D/A converter 8 for converting the signals decoded by the MPEG decoder 7 to analog signals which can be outputted to a monitor 20, a first controller 9 for controlling each portion of the backend 1, a wireless remote controller (not illustrated) used to input various instructions into the optical disc recorder, and a timer (not illustrated) for processing timer recoding.

Even though the tuner 3 supports digital broadcasting, analog broadcasting may be coupled with. When tuner 3 supports analog broadcasting, an A/D converter to convert the analog signals that tuner 3 received into digital signals is necessary separately.

On the other hand, the front end 2 comprises a second buffer 11 for transmitting and receiving signals with respect to the first buffer 6, an EFM (Eight Fourteen Modulation) modulator 12 for modulating signals (8 bits signals) accumulated into the second buffer 11 to 14 bits signals proper to be recorded onto the optical disc, a spindle motor 13 for revolving the optical disc, an optical pickup 14 for emitting laser beams to the optical disc while it has been revolved so as to record and reproduce the signals on and from the optical disc, an EFM demodulator 15 for modulating 14 bits signals reproduced by the optical pickup 14 to 8 bits signals, and a second controller 16 for controlling each element of the front end 2 corresponding to control signals outputted from the first controller 9.

The first controller 9 of the backend 1 and the second controller 16 of the front end 2 are connected in a manner so that various control signals can be transmitted and received between them. And the first buffer 6 of the backend 1 and the second buffer 11 of the front end 2 are also connected in a manner so that the MPEG encoded signals can be transmitted and received between them.

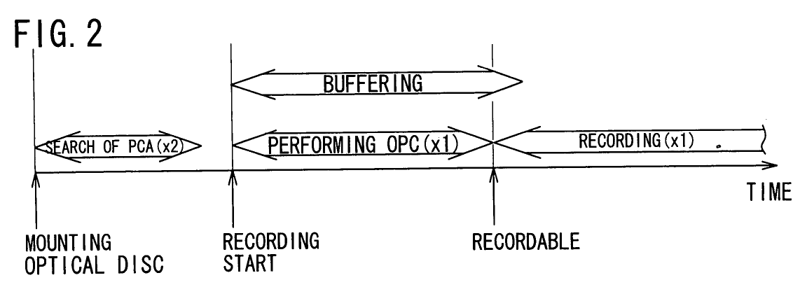

FIG. 2 shows operations of the optical disc recorder at an initial state of recording in chronological order. In FIG. 2, symbols x1 and x2 designate to magnifications of revolution speed of the optical disc with respect to the normal revolution speed.

When mounting of an optical disc onto the front end 2 is completed, the optical disc recorder drives the spindle motor 13 immediately for revolving the optical disc at a double speed (first revolution speed) of a normal revolution speed (second revolution speed), and the optical pickup 14 emits laser beam to the optical disc for searching a power calibration area. When the search of the power calibration area is completed, the optical disc recorder shifts a standby mode for waiting an instruction to start the recording. Under such a standby mode, when a recording key of the wireless remote controller is operated by a user, or when reservation recording time set beforehand by the user comes close, the optical disc recorder starts recording. When recording is started, the optical disc apparatus starts optimum power control and starts to accumulate the MPEG encoded signals formed by the MPEG encoder 5 into the first buffer 6 of the backend 1, simultaneously. The optimum power control is performed as follows. The spindle motor 13 is driven for revolving the optical disc at a normal revolution speed. The optical pickup 14 emits laser beam to power calibration area of the revolved optical disc while varying the power of the laser beam as test writing. The optical pickup 14 further emits laser beam power of which is weaker than that used for test writing and receives reflected light from the optical disc so as to read the signals as test writing recorded on the power calibration area of the optical disc. The first controller 9 evaluates the reflected light received by the optical pickup 14 so as to find the most suitable power of the laser beam for the optical disc loaded on.

Hereupon, the power calibration areas are generally formed not only in the vicinity of inner periphery but also in the vicinity of outer periphery of the optical disc. Furthermore, the optical disc is not necessarily mounted horizontally on the revolution table of the recorder. Thus, the controller further performs tilt adjustment just after the optical disc is mounted on the recorder. It is possible to search the power calibration area formed in the vicinity of outer periphery of the optical disc, simultaneously to the tilt adjustment.

When the optimum power control is completed, and the most suitable laser power for the optical disc loaded on is found, it becomes in a condition that signals are recordable onto the optical disc. Therefore, the optical disc recorder starts to transmit the signals accumulated into the first buffer 6 of the backend 1 to the second buffer 11 of the front end 2 and to record the signals onto the optical disc through the EFM modulator 12 and the optical pick-up 14. These operations are carried out by cooperation of the first controller 9 of the backend 1 with the second controller 16 of the front end 2.

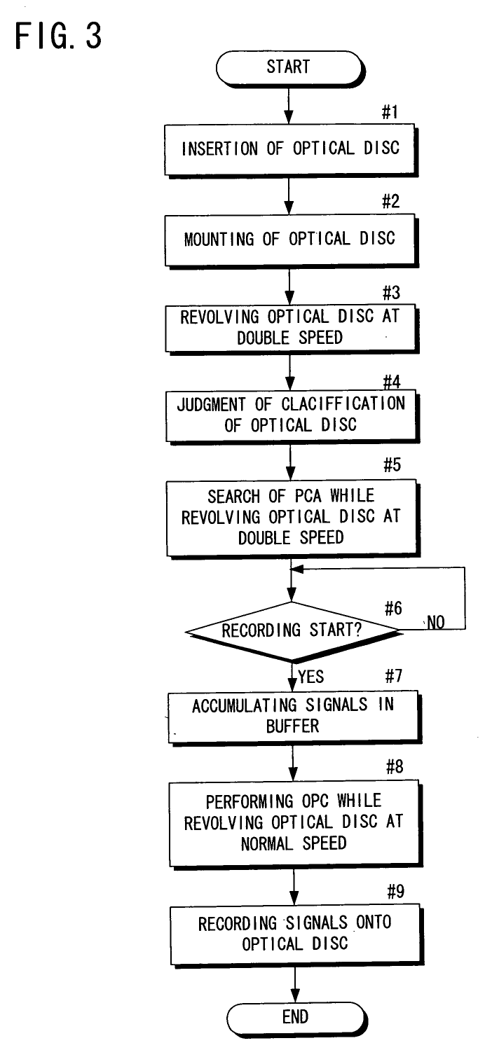

Subsequently, the operations of the optical disc recorder from the loading of the optical disc to the recording of signals onto the optical disc are described with reference to FIG. 3. When the optical disc is disposed on a table (not shown) and the table is pulled into an inside of the optical disc recorder, that is the optical disc is inserted into the optical disc recorder (#1), the optical disc will be mounted on the revolving table 5 (#2). Subsequently, the spindle motor 13 is driven for revolving the optical disc at the double speed of the normal revolution speed (#3), the optical pickup 14 emits the laser beam to the optical disc so as to judge the classification of the optical disc based on reflected light from the optical disc (#4). When the classification of the optical disc is judged, the loading operation of the optical disc is completed. Subsequently, the power calibration area (PCA) onto the optical disc is searched while the optical disc is revolved at the double speed of the normal revolution speed (#5). As mentioned above, when the power calibration area is searched, the optical disc recorder shits to the standby mode. Under the standby mode, when the recording key of the wireless remote controller is operated by the user or the reservation recording time set beforehand by the user comes close, the optical disc recorder starts the recording of the signals corresponding to the television broadcast signals (YES in step #6).

Recording operation is made in the following procedures. In the optical disc recorder, the MPEG encoder 5 encodes the television broadcast signals received by the tuner 3, and the MPEG encoded signals are accumulated into the first buffer 6 of the backend 1 (#7). Accumulation of the MPEG encoded signal to the first buffer 6 is performed appropriately till recording processing is completed. Simultaneously, the spindle motor 13 is driven for revolving the optical disc at the normal revolution speed, and the optimum power control (OPC) is performed (#8). When the optimum power control is completed, the optical disc recorder immediately starts to transmit the MPEG encoded signals accumulated into the first buffer 6 of the backend 1 in the step #7 to the second buffer 11 of the front end 2 so as to start the recording the signals onto a recording area of the optical disc, while the revolution speed of the optical disc in maintained at the normal revolution speed (#9).

As described above, the optical disc recorder in accordance with the embodiment immediately judges the classification of the optical disc just after the optical disc is mounted on the revolution table thereof, and searches the power calibration area, subsequently. Thus, it is possible to shorten a time for the preparations performed prior to start the recording of the signals onto the optical disc, after inputting of an instruction to start the recording. Consequently, the capacity of the first buffer 6 of the backend 1 can be made smaller, and the cost of the optical disc recorder can be lowered. When it is assumed that a time necessary for performing the optimum power control is about eight seconds, a memory which can accumulate the MPEG encoded signal corresponding to about ten second of television broadcast signals can be used as the first buffer 6 of the backend 1.

In the conventional optical disc recorder, the search of the power calibration area is performed while the optical disc is revolved at the normal revolution speed. The time necessary for searching the power calibration area was about eight seconds. On the other hand, in the optical disc recorder in accordance with the embodiment, the search of the power calibration area is performed while the optical disc is revolved at the double speed of the normal revolution speed, so that the time necessary for searching the power calibration area is shortened to about four seconds. The search of the power calibration area can be completed promptly. Consequently, even when the instruction to start the recording is inputted just after the optical disc is loaded on the optical disc recorder, the optical disc recorder can be shifted to a state that the television broadcast signals received by the tuner 3 can be recorded promptly, so that the overflow of the first buffer 6 of the backend 1 can be prevented.

Furthermore, in the optical disc recorder in accordance with the embodiment, when the instruction to start the recording is inputted, the power of the laser beam emitted from the optical pickup 14 is optimized while the optical disc is revolved at the normal revolution speed, and the modulated signals by the EFM modulator 12 is recorded onto the optical disc while the normal revolution speed of the optical disc is maintained. Thus, it is no need to wait the start of recording of the signals for varying the revolution speed of the optical disc. Thus, it is possible to start the recording of signals onto the optical disc just after the completion of the optimum power control of the laser beam emitted from the optical pickup 14. Consequently, the time delay to start the recording of signals onto the optical disc can be shortened much more.

In addition, as for the present invention, various kinds of transformation are possible without being limited to constitution of the above-mentioned embodiment. For example, in the steps #3 to #5 in the flowchart shown in FIG. 3, the optical disc is revolved at double speed of the normal revolution speed. The double speed of revolution speed of the optical disc, however, is established by counterpoising the shortening in processing time and the noise due to vibration of the optical disc. Therefore, it may be revolved at normal revolution speed, at the thrice or quadruple of the normal revolution speed, corresponding to the destination or use of the optical disc recorder. In addition, the optimum power control is performed in the step #8 after the instruction to start the recording is inputted in the step #6. This is considered not to give uneasy feeling to a user due to the optical disc recorder performs any operation, even though the user inputs no instruction. Therefore, the flowchart may be changed to perform the optimum power just after the search of the power calibration area in the step #5 is completed, when it is unnecessary such a consideration.

Still furthermore, the encoder 5 and the decoder 7 may be based on other standards without being limited to the MPEG standard. In addition, the buffer to accumulate recording signals may be the second buffer 11 of the front end 2 without being limited to the first buffer 6 of the backend 1.

This application is based on Japanese patent application 2004-86205 filed Mar. 24, 2004 in Japan, the contents of which are hereby incorporated by references.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

1. An optical disc recorder comprising:
a tuner receiving television broadcast signals;
an encoder for compressing and encoding the television broadcast signals received by the tuner;
a buffer for temporarily accumulating signals compressed and encoded by the encoder;
a modulator for modulating the signals accumulated into the buffer to signals appropriate to be recorded on an optical disc;
a spindle motor for revolving the optical disc;
an optical pickup for emitting laser beam to the optical disc while it is revolved by the spindle motor so as to record the signals modulated by the modulator onto the optical disc; and
a controller for controlling each component of the recorder; and wherein
the spindle motor revolves the optical disc just after the optical disc is mounted on the recorder at a first revolution speed;
the optical pickup emits the laser beam to the optical disc revolved and receives reflected light from the optical disc;
the controller judges classification of the optical disc based on the reflected light received by the optical pickup;
when the classification of the optical disc is judged, the spindle motor maintains revolution of the optical disc at the first revolution speed and the optical pickup emits the laser beam for searching a power calibration area; and
when the power calibration area is searched, the controller shifts to standby mode to wait an instruction to start recording television broadcast signals onto the optical disc.

2. The optical disc recorder in accordance with claim 1, wherein
when the instruction to start recording television broadcast signals is inputted, the spindle motor revolves the optical disc at a second revolution speed, the optical pickup emits the laser beam to the power calibration area on the optical disc with varying power of the laser beam for performing optimum power control, and the buffer temporarily accumulates the signals compressed and encoded by the encoder simultaneously.

3. The optical disc recorder in accordance with claim 2, wherein
when the optimum power control is completed, the modulator starts to modulate the signals accumulated into the buffer to signals appropriate to be recorded on an optical disc, and the optical disc pickup the laser beams to a recording area of the optical disc for recording the signals corresponding to the television broadcast signals received by the tuner onto the optical disc.

4. The optical disc recorder in accordance with claim 1, wherein
the first revolution speed is a double, a thrice or a quadruple speed of the second revolution speed.

5. The optical disc recorder in accordance with claim 1, wherein
the first revolution speed is the same as the second revolution speed.

6. The optical disc recorder in accordance with claim 1, wherein
the controller further performs tilt adjustment when the optical disc is mounted on the recorder, and searches the power calibration area formed in the vicinity of outer periphery of the optical disc, simultaneously.

7. An optical disc recorder comprising:
a tuner receiving television broadcast signals;
an encoder for compressing and encoding the television broadcast signals received by the tuner;
a buffer for temporarily accumulating signals compressed and encoded by the encoder;
a modulator for modulating the signals accumulated into the buffer to signals appropriate to be recorded on an optical disc;
a spindle motor for revolving the optical disc;
an optical pickup for emitting laser beam to the optical disc while it is revolved by the spindle motor so as to record the signals modulated by the modulator onto the optical disc; and
a controller for controlling each component of the recorder; wherein
the spindle motor revolves the optical disc just after the optical disc is mounted on the recorder at a first revolution speed faster than a second revolution speed while signals are recorded onto the optical disc;
the optical pickup emits the laser beam to the optical disc while revolving at the first revolution speed, and receives reflected light from the optical disc;
the controller judges classification of the optical disc based on the reflected light received by the optical pickup;
when the classification of the optical disc is judged, the spindle motor revolves the optical disc at the first revolution speed and the optical pickup emits the laser beam for searching a power calibration area;
when the power calibration area is searched, the controller shifts to standby mode to wait an instruction to start recording television broadcast signals onto the optical disc;
when the instruction to start recording television broadcast signals is inputted, the spindle motor revolves the optical disc at the second revolution speed, the optical pickup emits the laser beam to the power calibration area on the optical disc with varying power of the laser beam for performing optimum power control and the buffer temporarily accumulates the signals compressed and encoded by the encoder, simultaneously; and
when the optimum power control is completed, the modulator starts to modulate the signals accumulated into the buffer to signals appropriate to be recorded on an optical disc, and the optical pickup emits the laser beams to a recording area of the optical disc revolved at the second revolving speed for recording the signals corresponding to the television broadcast signals received by the tuner onto the optical disc.

8. The optical disc recorder in accordance with claim 7, wherein
the first revolution speed is a double, a thrice or a quadruple speed of the second revolution speed.
